(19) United States
(12) Patent Application Publication
(10) Pub. No.: US 2012/0030543 A1
(43) Pub. Date: Feb. 2, 2012

(54) PROTECTION OF APPLICATION IN MEMORY

(75) Inventors: Yi Ge, Beijing (CN); Rui Hou, Beijing (CN); Li Li, Beijing (CN); Liang Liu, Beijing (CN)

(73) Assignee: International Business Machines Corporation, Armonk, NY (US)

(21) Appl. No.: 13/180,713

(22) Filed: Jul. 12, 2011

(30) Foreign Application Priority Data
Jul. 30, 2010 (CN) 201010244715.3

(51) Int. Cl. G06F 11/10

(52) U.S. Cl. 714/766; 714/E11.044

(57) ABSTRACT

A method, a memory controller and a processor architecture for protecting an application in a memory are disclosed. The application is cached as memory lines according to a size of a cache line. For example, the method comprises: in response to a load access request from a processor, reading from the memory a flagged memory line and an ECC checksum corresponding to the memory line, wherein the flagged memory line is obtained by performing a logic operation on a predetermined bit of the memory line and a flag bit for identifying the memory line; performing an ECC check on the flagged memory line by using the ECC checksum to obtain a value of the flag bit of the memory line; restoring the flagged memory line to the memory line according to the value of the flag bit; and determining whether or not to load the memory line according to the value of the flag bit and the type of the load access request from the processor.

### PRIORITY CLAIM

The present application claims priority to the Chinese patent application identified as 201010244715.3, filed on Jul. 30, 2010, and entitled “Method, Memory Controller and Processor for Protecting Application in Memory,” the disclosure of which is incorporated by reference herein in its entirety.

### FIELD OF THE INVENTION

The present invention relates to an application in a memory, and more specifically, to a method, a memory controller and a processor architecture for protecting an application in the memory.

### BACKGROUND OF THE INVENTION

Cloud computing is a new Internet-based computing mode which provides computation-on-demand for individuals and enterprises through heterogeneous, autonomous services on the Internet. Cloud computing is generally considered to comprise the following levels of services: Infrastructure as a Service (IaaS), Platform as a Service (PaaS) and Software as a Service (SaaS). However, the cloud computing environment lacks visibility and controllability, and the applications are executed outside the enterprise network, so it is difficult to guarantee security of the applications in the cloud computing environment. Unauthorized intruders such as hackers often utilize network loopholes to obtain accesses and unauthorized rights, and steal and crack the applications, so that critical information data including business secrets and personal privacies of the users are leaked out, thereby bringing irreparable losses to the users.

Although the users can utilize software-implemented security schemes and mechanisms to construct a trusted computing system in the cloud computing environment, e.g., software authorization and authentication, those experienced hackers can read and crack secret keys, and as a result, the applications are stolen and cracked. There are even more uncertain factors in a virtual memory-sharing environment, therefore, it is a great challenge in the remote cloud computing environment to guarantee the security of the applications in the memory, such that they are not stolen and cracked.

### SUMMARY OF THE INVENTION

Illustrative embodiments of the invention provide a method, a memory controller and a processor architecture for protecting an application in a memory.

According to a first aspect of the invention, a method of protecting an application in a memory is provided, the application being cached as memory lines according to a size of cache line, the method comprising: in response to a load access request from a processor, reading from the memory a flagged memory line and an ECC checksum corresponding to the memory line, wherein the flagged memory line is obtained by performing a logic operation on a predetermined bit of the memory line and a flag bit for identifying the memory line; obtaining a value of the flag bit of the memory line by performing an ECC check on the flagged memory line; restoring the flagged memory line to the memory line according to the value of the flag bit; and determining whether or not to load the memory line according to the value of the flag bit and the type of the load access request from the processor.

According to a second aspect of the invention, a memory controller for protecting an application in a memory is provided, the application being cached as memory lines according to a size of a cache line, the memory controller comprising: a reading module configured to, in response to a load access request from a processor, read from the memory a flagged memory line and an ECC checksum corresponding to the memory line, wherein the flagged memory line is obtained by performing a logic operation on a predetermined bit of the memory line and a flag bit for identifying the memory line; an ECC check module configured to obtain a value of the flag bit of the memory line by performing an ECC check on the flagged memory line; a restoring module configured to restore the flagged memory line to the memory line according to the value of the flag bit; and a load determining module configured to determine whether or not to load the memory line according to the value of the flag bit and the type of the load access request from the processor.

According to a third aspect of the invention, a processor architecture comprising the memory controller according to the second aspect of the invention is provided.

Advantageously, the method, memory controller and processor architecture according to the embodiments of the invention protect the application in the memory by hardware implementation, and thus effectively prevent the application from being stolen and cracked in a remote application environment.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram showing processor architecture for providing a protection mechanism for an application in a memory, according to an embodiment of the invention;

FIG. 2 shows a method of protecting an application in a memory implemented in a memory controller, according to an embodiment of the invention;

FIG. 3 shows a process of loading a flagged memory line and an ECC checksum into a memory, according to an embodiment of the invention;

FIG. 4 shows an example of generating a flagged memory line and ECC coding;

FIG. 5 shows an example of performing an ECC check on a flagged memory line to obtain a flag bit;

FIG. 6 shows a state table for determining a value of a flag bit of a memory line according to a first check result and a second check result, according to an embodiment of the invention;

FIG. 7 shows an example of determining a value of a flag bit by using majority decision;

FIG. 8 is a block diagram showing a memory controller for protecting an application in a memory, according to an embodiment of the invention;

FIG. 9 shows a true value table of hardware control logic for loading an application; and

FIG. 10 is a schematic diagram showing a control logic circuit for loading an application.

### DETAILED DESCRIPTION

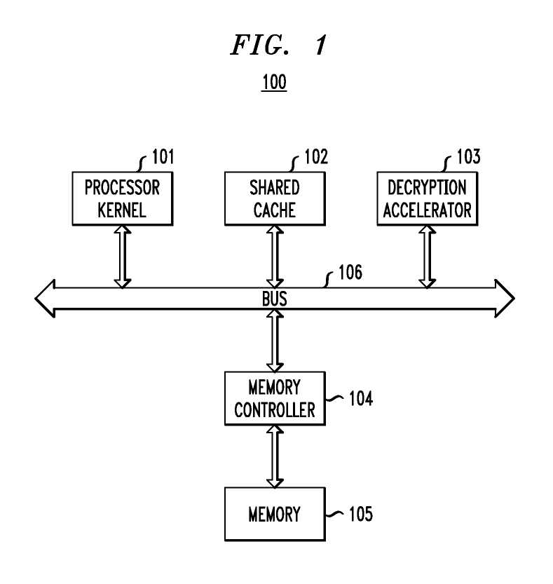

In accordance with an illustrative embodiment of the invention, a method of protecting the application in the memory is implemented on a processor which provides a decryption accelerating function. FIG. 1 is a diagram showing processor architecture for providing a protection mechanism for the application in the memory, according to an embodiment of the invention. As shown, the processor architecture 100 comprises a processor kernel 101, a shared cache 102, a decryption accelerator 103, a memory controller 104, and memory 105. A bus 106 couples the architecture components as shown.

By using a decryption accelerator 103 specially composed of hardware circuit units for decrypting the encrypted application codes, a risk of the application codes being cracked or read possibly during software decryption can be avoided. A core idea of the invention is to protect application executable codes in the memory, to set protection flag bits for those applications requiring particular protection, and to improve the existing mechanism of performing an ECC (Error Check and Correction) check on the data in the memory, so as to effectively identify the protection flag bits of the application in the memory, thereby refusing a load data access request from the processor.

As illustratively used herein, the term “application” refers to one or more computer programs or one or more sets of program instruction code that are designed to perform one or more functions when executed.

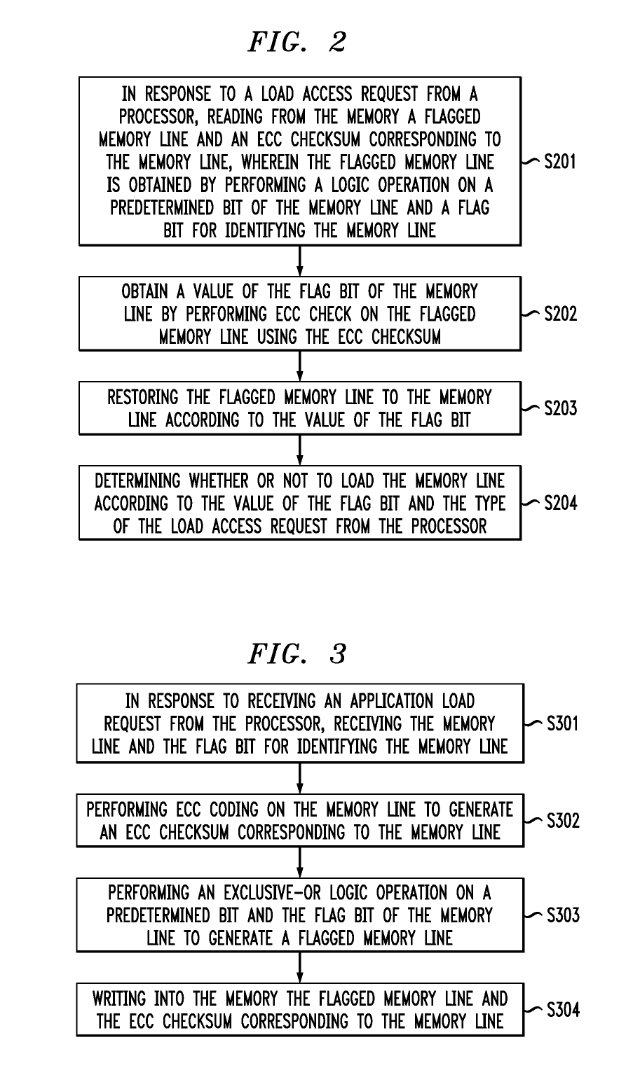

FIG. 2 shows a method of protecting an application in a memory (105) implemented in a memory controller (104), according to an embodiment of the invention. The application is cached (102) as memory lines according to a size of a cache line. The method comprises a step S201 of, in response to a load access request from a processor (101), reading from the memory a flagged memory line and an ECC checksum corresponding to the memory line. The flagged memory line is obtained by performing a logic operation on a predetermined bit of the memory line and a flag bit for identifying the memory line. A step S202 obtains a value of the flag bit of the memory line by performing an ECC check on the flagged memory line using the ECC checksum. A step S203 restores the flagged memory line to the memory line according to the value of the flag bit. A step S204 determines whether or not to load the memory line according to the value of the flag bit and the type of the load access request from the processor.

Specifically, at the step S201, in response to a load access request from the processor, a flagged memory line and an ECC checksum corresponding to the memory line are read from the memory, wherein the flagged memory line is obtained by performing a logic operation on a predetermined bit of the memory line and a flag bit for identifying the memory line. FIG. 3 shows a process of loading to the memory the flagged memory line and the ECC checksum, according to an embodiment of the invention.

At a step S301, in response to receiving an application load request from the processor (101), the memory line and the flag bit for identifying the memory line are received. Specifically, according to an embodiment of the invention, for the case of protecting the application, upon receiving the application load request from the processor, a DMA (direct memory access) controller loads the encrypted applications from a hard disk to the memory (105). A decryption accelerator (103) receives a decryption control instruction issued from the processor and extracts from the decryption control instruction a memory address of the encrypted application. The decryption accelerator reads from the extracted memory address the encrypted application and decrypts it, and sets a protection flag bit, e.g., “1”, for the decrypted application, indicating that the application needs protection. The decryption accelerator then writes the decrypted application to the memory each time according to the size of the cache line, for example, if the size of the cache line is 128 bytes, each time application codes of 128 bytes are written to the memory and are stored as a memory line. Furthermore, in order to effectively record the flag bits, a one-bit data line for recording the flag bits is additionally added on a data bus (106) between the processor (101) and the memory controller (104). Therefore, a plurality of memory lines and corresponding flag bits are cached into the memory controller before being written into the memory. However, for other cases where protection is not needed, it is in fact unnecessary to add additional flag bits, i.e., the added non-protection flag bits are “0” by default.

At a step S302, ECC coding is performed on the memory line to generate an ECC checksum corresponding to the memory line. The memory is an electronic device and errors are hard to avoid during its operation. However, for those users who require high stability, memory errors will possibly cause serious problems. Therefore, the memory of the server system is generally protected by an ECC (Error Check and Correction) check, so that the whole server system is more safe and stable during operation.

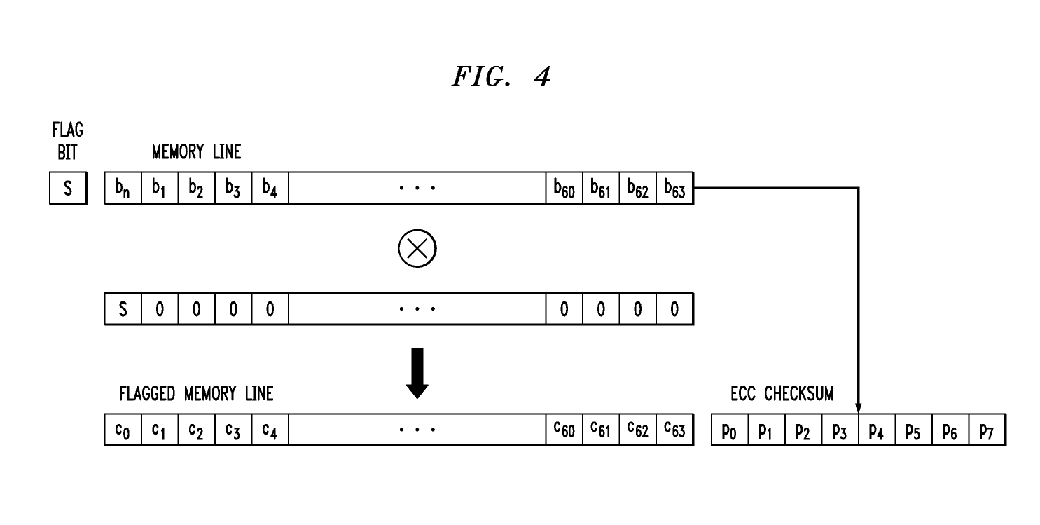

FIG. 4 shows an example of generating the flagged memory line and ECC coding, wherein b₀, b₁ . . . b₆₃ is a memory line of 64 bits, and bit “s” is a flag bit added for the memory line. Eight Single Error Correction Double Error Detection (SECDED) bits, namely, p₀ . . . p₇, are generated for every 64-bit instruction data b₀, b₁ . . . b₆₃ by using the well-known ECC encoding method.

At a step S303, an exclusive-OR logic operation is performed on a predetermined bit and the flag bit of the memory line to generate the flagged memory line. With reference to FIG. 4, among the memory line b₀, b₁ . . . b₆₃, b₀ is designated as the predetermined bit, and by performing the exclusive-OR operation on b0 and the flag bit s, a flagged memory line c₀, c₁ . . . c₆₃ for the memory line b₀, b₁ . . . b₆₃ is generated.

At a step S304, the flagged memory line and an ECC checksum corresponding to the memory line are written into the memory.

After finishing loading of the application into the memory, the processor issues an instruction or data load request. Specifically, at the step S201, in response to receiving the load request from the processor, the memory controller reads from the memory a plurality of flagged memory lines and ECC checksums corresponding to the plurality of memory lines, by taking FIG. 4 as an example, a plurality of flagged memory lines c₀, c₁ . . . c₆₃ and a plurality of corresponding 8 Single-Error Correction Double-Error Detection (SECDED) bits p₀ . . . p₇.

At the step of S202, an ECC check is performed on the flagged memory line by using the ECC checksum to obtain a value of the flag bit of the memory line. Specifically, the ECC check is performed on the flagged memory line to generate a first check result. A non-logic operation is performed on the predetermined bit of the flagged memory line to generate a new flagged memory line, wherein the predetermined bit of the flagged memory line corresponds to and coincides with the predetermined bit for generating the flagged memory line. The ECC check is performed on the new flagged memory line to generate a second check result. A value of the flag bit of the memory line corresponding to the flagged memory line is obtained according to the first check result and the second check result. Those skilled in the art would appreciate that generation of the flagged memory line from the memory line and the flag bit is not limited to the logic OR operation but may be implemented by any logic operation having a function of restoring the value of the flag bit.

A value of the flag bit of the memory line corresponding to the flagged memory line is determined according to the first check result and the second check result. A method of determining the value of the flag bit includes the following steps. If the first check result indicates that the predetermined bit of the flagged memory line is in error, and the second check result indicates that the new flagged memory line has no error, the value of the flag bit is determined as a protection flag bit. If the first check result indicates that the flagged memory line has no error, and the second check result indicates that a predetermined bit of the new flagged memory line is in error, the value of the flag bit is determined as a non-protection flag bit. If the first check result indicates that the flagged memory line has two bits in error, and the second check result indicates that the new flagged memory line has one bit other than the predetermined bit in error, the value of the flag bit is determined as a protection flag bit. If the first check result indicates that the flagged memory line has one bit other than the predetermined bit in error, and the second check result indicates that the new flagged memory line has two bits in error, the value of the flag bit is determined as a non-protection flag bit. Lastly, if the first check result and the second check result both indicate that the memory line has two or more bits in error, the value of the flag bit presents an unknown and uncertain state.

According to an embodiment of the invention, after determining the value of the flag bit corresponding to each memory line according to the method of the embodiment of the invention, in order to avoid more than two error codes caused by transmission error, which result in an uncertain value of the flag bit, for the memory line that is written once according to the size of the cache line, the value of the flag bit is determined further according to the principle of majority decision. Because an identical flag bit is set for the memory line written into the memory each time according to the size of the cache line, a correct value of the flag bit can be determined according to the principle of majority decision for the memory line written once according to the size of the cache line.

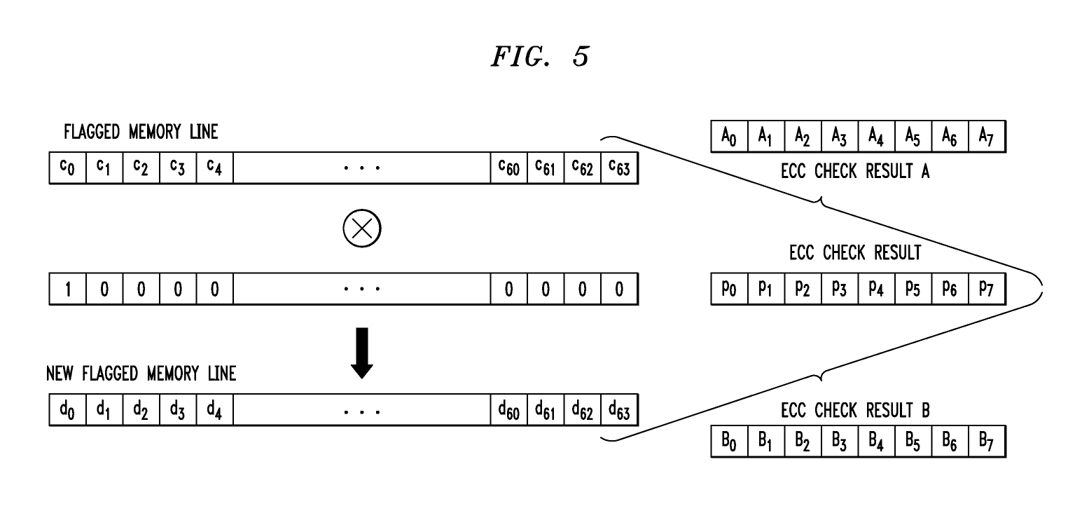

FIG. 5 shows an example of performing an ECC check on the flagged memory line to obtain a flag bit. Firstly, an ECC check is performed on the flagged memory line c₀, c₁ . . . c₆₃ by using the eight Single-Error Correction Double-Error Detection (SECDED) bits p₀ . . . p₇ to generate a 8-bit first ECC check result A (A₀ . . . A₇). Then, a non-logic operation is performed on the flag bit c₀ in the flagged memory line c₀, c₁ . . . c₆₃, i.e., an exclusive-OR operation is performed on c₀ and “1”, to generate a new flagged memory line d₀, d₁ . . . d₆₃. Then, an ECC check is performed on the new flagged memory line d₀, d₁ . . . d₆₃ by using the eight Single-Error Correction Double-Error Detection (SECDED) bits p₀ . . . p₇ to generate a 8-bit second ECC check result B (B₀ . . . B₇). Since the Single-Error Correction Double-Error Detection (SECDED) bits of ECC can correct 1 bit error and detect two bit errors, 1 bit error can be corrected and 2 bit errors can be detected according to the ECC check result A₀ . . . A₇ and the ECC check result B₀ . . . B₇. The value of the flag bit is determined by combining correction and detection results A₀ . . . A₇ and B₀ . . . B₇.

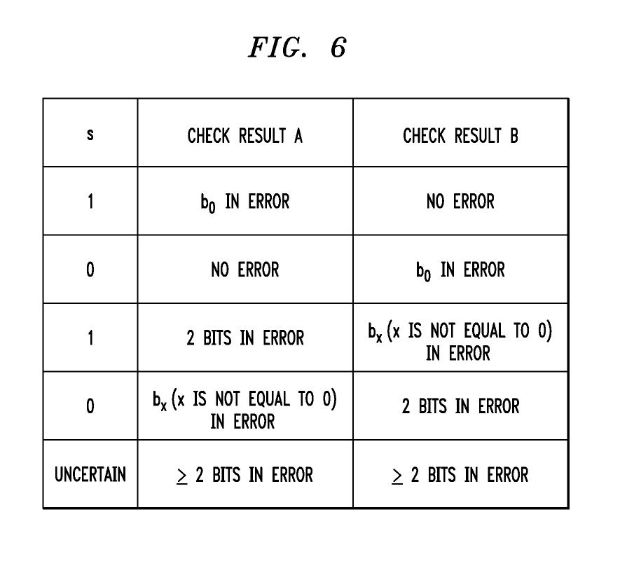

FIG. 6 shows a state table for determining a value of the flag bit of the memory line according to a first check result A and a second check result B, according to an embodiment of the invention. The table shows the following five situations:

(1) if the first check result A indicates that the predetermined bit b₀ of the flagged memory line c₀, c₁ . . . c₆₃ is in error, and the second check result B indicates that the memory line b₀, b₁ . . . b₆₃ has no error, the value of the flag bit s is determined as the protection flag bit “1”;

(2) if the first check result A indicates that the memory line b₀, b₁ . . . b₆₃ has no error, and the second check result B indicates that the predetermined bit b₀ of the memory line b₀, b₁ . . . b₆₃ is in error, the value of the flag bit s is determined as the non-protection flag bit “0”;

(3) if the first check result A indicates that there are two bits in error, and the second check result B indicates that the memory line b₀, b₁ . . . b₆₃ has a bit bₓ other than the predetermined bit b₀ in error, the value of the flag bit s is determined as the protection flag bit “1”;

(4) if the first check result A indicates that the memory line b₀, b₁ . . . b₆₃ has a bit bₓ other than the predetermined bit b₀ in error, and the second check result B indicates that the memory line b₀, b₁ . . . b₆₃ has two bits in error, the value of the flag bit s is determined as the non-protection flag bit “0”; and

(5) if the first check result and the second check result both indicate that the memory line b₀, b₁ . . . b₆₃ has two or more bits in error, the value of the flag bit presents an unknown and uncertain state.

In order to avoid the fifth situation, according to an embodiment of the invention, a majority decision may be used for guaranteeing correctness of the value of the flag bit s. FIG. 7 shows an example of determining a value of the flag bit s by using majority decision. Assuming that the size the cache line is 32 bytes, so data once written to the memory controller is the 32 bytes plus a flag bit, thus 4 memory lines are generated. For the instruction data of 32 bytes written once, since the flag bit is identical, after determining the value of the flag bit corresponding to each memory line according to the method of the embodiment of the invention, a correct value of the flag bit is determined according to the principle of majority decision. As shown in FIG. 7, from the first check result A and the second check result B of the respective memory lines, values of four flag bits s are respectively obtained, namely, 1, 1, 0, 1. The value of the flag bit s determined by majority decision is the protection flag bit “1”, so as to avoid more than two error codes caused by transmission error which results in an uncertain value of the flag bit.

Returning to step S203 in FIG. 2, the plurality of flagged memory lines are restored to the memory line according to the value of the flag bit. According to the example of FIG. 5, it is predetermined that the protection flag bit is “1” and the non-protection flag bit is “0”. In this case, if the first situation is satisfied, that is, the first check result A indicates that the predetermined bit b₀ is in error, and the second check result B indicates no error, the value of the flag bit s is determined as “1”, so a non-logic operation is performed on c₀ to restore the original memory line b₀, b₁ . . . b₆₃. If the second situation is satisfied, that is, if the first check result A indicates no error, and the second check result B indicates that the predetermined bit b₀ is in error, the value of the flag bit s is determined as “0”, so the flagged memory line c₀, c₁ . . . c₆₃ is the original memory line b₀, b₁ . . . b₆₃. If the third situation is satisfied, that is, the first check result A indicates that there are two bits in error, and the second check result B indicates that there is one bit bₓ other than the predetermined bit in error b₀, the value of the flag bit s is determined as “1”, so a non-logical operation is performed on c₀ and on cₓ to restore the original memory line b₀, b₁ . . . b₆₃. If the fourth situation is satisfied, that is, the first check result A indicates that there is one bit bₓ other than the predetermined bit b₀ in error, and the second check result B indicates that there are two bits in error, the value of the flag bit s is determined as “0”, so the flagged memory line c₀, c₁ . . . c₆₃ is the original memory line b₀, b₁ . . . b₆₃, thereby restoring the original memory line b₀, b₁ . . . b₆₃.

At step S204, it is determined whether or not to load the memory line according to the value of the flag bit and the access type of the processor. Specifically, if it is determined that the value of the flag bit is the protection flag bit and the access type of the processor is a data acquisition request, it is prohibited to load the application into the data cache (D-cache), thereby protecting the application and preventing the application from being read and cracked. If it is determined that the value of the flag bit is the protection flag bit and the access type is an instruction acquisition request, it is allowed to load the application into the instruction cache (I-cache), thereby performing the application. If it is determined that the value of the flag bit is the non-protection flag bit and the access type is a data acquisition request, it is allowed to load the application into the data cache (D-cache). If it is determined that the value of the flag bit is the non-protection flag bit and the access type is an instruction acquisition request, it is allowed to load the application into the instruction cache (I-cache).

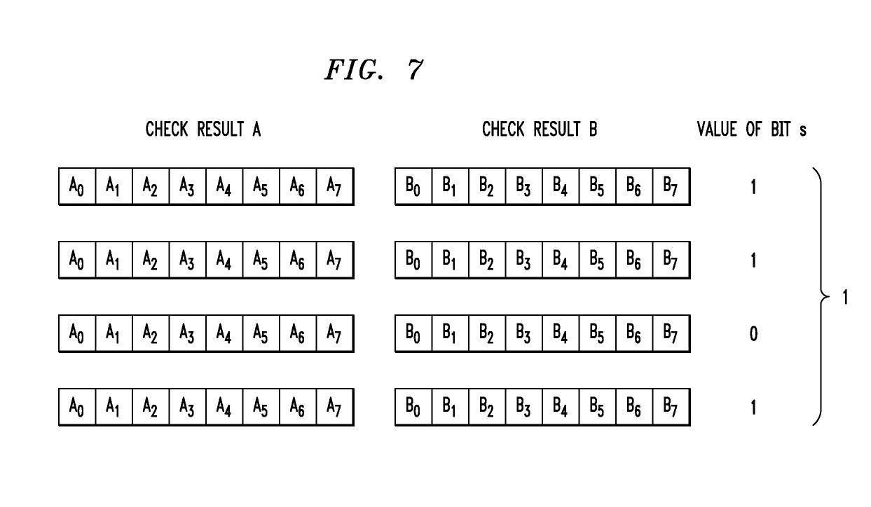

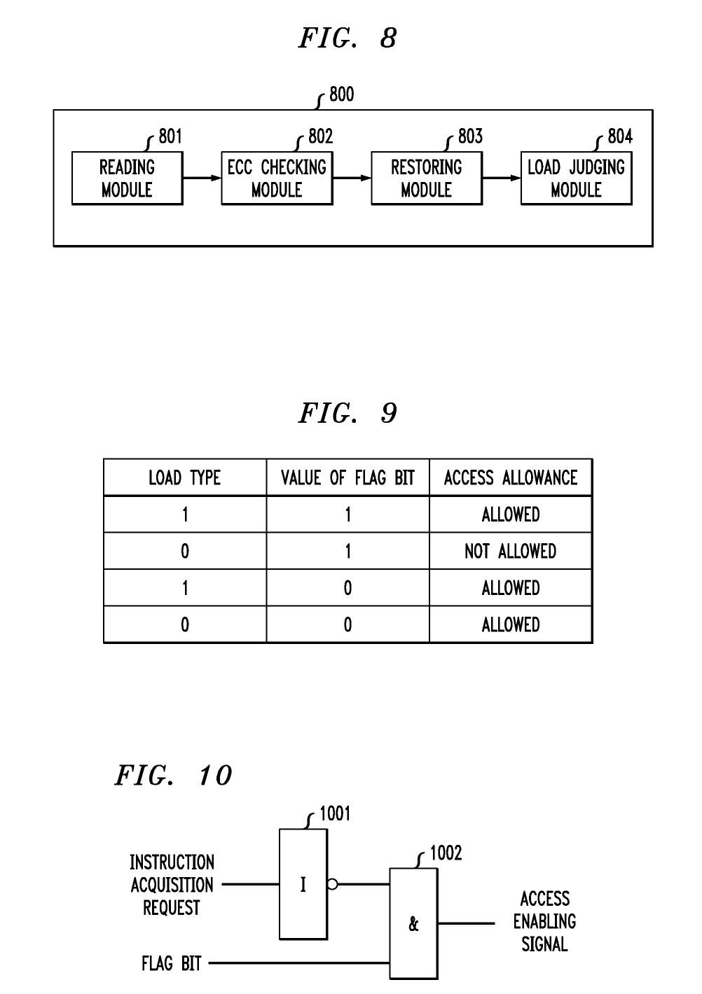

Based on the same inventive concepts described above, embodiments of the invention propose a memory controller for protecting application in the memory. FIG. 8 is a block diagram showing a memory controller 800 for protecting an application in the memory according to an embodiment of the invention. The memory controller 800 comprises a reading module 801 configured to, in response to a load access request from a processor, read from the memory a flagged memory line and an ECC checksum corresponding to the memory line, wherein the flagged memory line is obtained by performing a logic operation on a predetermined bit of the memory line and a flag bit for identifying the memory line. The memory controller 800 also comprises an ECC check module 802 configured to obtain a value of the flag bit of the memory line by performing ECC check on the flagged memory line. Further, the memory controller 800 comprises a restoring module 803 configured to restore the flagged memory line to the memory line according to the value of the flag bit. Still further, the memory controller 800 comprises a load determining (judging) module 804 configured to determine whether or not to load the memory line according to the value of the flag bit and the type of the load access request from the processor.

The memory controller further comprises: a receiving module configured to, in response to receiving an application load request from the processor, receive from a decryption accelerator the memory line and the flag bit for identifying the memory line; an ECC coding module configured to perform ECC coding on the memory line to generate an ECC checksum corresponding to the memory line, wherein the ECC coding module can be implemented by any well-known ECC coding hardware implementations; a flagged memory line generating module configured to perform an exclusive-OR on a predetermined bit and the flag bit of the memory line to generate a flagged memory line; and a memory writing module configured to write the flagged memory line and the ECC checksum corresponding to the memory line into the memory.

The ECC checking module is further configured to perform ECC check on the flagged memory line to generate a first check result; perform a non-logic operation on the predetermined bit of the flagged memory line to generate a new flagged memory line; perform ECC check on the new flagged memory line to generate a second check result; and obtain a value of the flag bit of the flagged memory line according to the first check result and the second check result, wherein the ECC checking module can be implemented on the basis of the existing ECC checking circuit.

According to an embodiment of the invention, if the first check result indicates that the predetermined bit of the flagged memory line is in error, and the second check result indicates that the new flagged memory line has no error, the value of the flag bit is determined as a protection flag bit. If the first check result indicates that the flagged memory line has no error, and the second check result indicates that a predetermined bit of the new flagged memory line is in error, the value of the flag bit is determined as a non-protection flag bit. If the first check result indicates that the flagged memory line has two bits in error, and the second check result indicates that the new flagged memory line has one bit other than the predetermined bit in error, e the value of the flag bit is determined as a protection flag bit. If the first check result indicates that the flagged memory line has one bit other than the predetermined bit in error, and the second check result indicates that the new flagged memory line has two bits in error, the value of the flag bit is determined as a non-protection flag bit. If the first check result and the second check result both indicate that the memory line has two or more bits in error, the value of the flag bit presents an unknown and uncertain state.

According to an embodiment of the invention, a determining module configured to determine a value of the flag bit corresponding to the memory line by using the principle of majority decision is provided.

According to an embodiment of the invention, the load determining module is further configured to: if it is determined that the value of the flag bit is the protection flag bit and the access type of the processor is a data acquisition request, it is prohibited to load the memory line; if it is determined that the value of the flag bit is the protection flag bit and the access type of the processor is an instruction acquisition request, then it is allowed to load the memory line; if it is determined that the value of the flag bit is the non-protection flag bit and the access type of the processor is a data acquisition request, it is allowed to load the memory line; if it is determined that the value of the flag bit is the non-protection flag bit and the access type of the processor is an instruction acquisition request, it is allowed to load the memory line. In hardware implementation, a control logic circuit is added according to the above loading logic for controlling loading of the application.

FIG. 9 shows a true value table of hardware control logic for loading the application, wherein the instruction acquisition request is denoted by “1”, the data acquisition request is denoted by “0”, the protection flag bit is denoted by “1”, and the non-protection flag bit is denoted by “0”. It can be seen that, only when the value of the flag bit is the protection flag bit and the access type is the data acquisition request, loading of the application is prohibited, and loading of the application is allowed in other cases.

FIG. 10 is a schematic diagram showing a control logic circuit for loading the application, wherein the logic control circuit comprises a combination of NOT gates (1001) and AND gates (1002) which can effectively prevent important application from being stolen or cracked.

Embodiments of the invention also provide a processor architecture for protecting an application in the memory, the processor architecture comprising a memory controller having the above characteristics.

As will be appreciated by one skilled in the art, aspects of the present invention may be embodied as a system, apparatus, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Referring again to FIGS. 1 through 10, the diagrams in the figures illustrate the architecture, functionality, and operation of possible implementations of systems, methods and computer program products according to various embodiments of the present invention. In this regard, each block in a flowchart or a block diagram may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagram and/or flowchart illustration, and combinations of blocks in the block diagram and/or flowchart illustration, can be implemented by special purpose hardware-based systems that perform the specified functions or acts, or combinations of special purpose hardware and computer instructions.

Accordingly, techniques of the invention, for example, as depicted in FIGS. 1-10, can also include, as described herein, providing a system, wherein the system includes distinct modules (e.g., modules comprising software, hardware or software and hardware). Such modules may be configured, for example, to perform the steps described and illustrated in the context of FIGS. 1-10.

One or more embodiments can make use of software running on a general purpose computer or workstation comprising a processing device, a memory, and an input/output interface formed, for example, by a display and a keyboard. The phrase “processing device” as used herein is intended to include (but not be limited to) any processing device, such as, for example, one that includes a CPU (central processing unit) and/or other forms of processing circuitry. Further, the phrase “processing device” may refer to more than one individual processing device. The term “memory” is intended to include (but not be limited to) memory associated with a processing device or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include (but not be limited to) one or more mechanisms for inputting data to the processing device (for example, keyboard or mouse), and one or more mechanisms for providing results associated with the processing device (for example, display or printer).

The processing device, memory, and input/output interface such as display and keyboard can be interconnected, for example, via bus as part of a data processing unit. Suitable interconnections, for example, via bus, can also be provided to a network interface, such as a network card, which can be provided to interface with a computer network, and to a media interface, such as a diskette or CD-ROM drive, which can be provided to interface with media.

A data processing system suitable for storing and/or executing program code can include at least one processing device coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboard, display, pointing device, and the like) can be coupled to the system either directly (such as via bus) or through intervening I/O controllers (omitted for clarity).

Network adapters such as network interface may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system running a server program. It will be understood that such a physical server may or may not include a display and keyboard. Also, such a computer architecture as described herein could represent an illustrative implementation of a client.

It will be appreciated and should be understood that the exemplary embodiments of the invention described above can be implemented in a number of different fashions. Given the teachings of the invention provided herein, one of ordinary skill in the related art will be able to contemplate other implementations of the invention. Indeed, although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method of protecting an application in a memory, the application being cached as memory lines according to a size of a cache line, the method comprising:
in response to a load access request from a processor, reading from the memory a flagged memory line and an error check and correction (ECC) checksum corresponding to the memory line, wherein the flagged memory line is obtained by performing a logic operation on a predetermined bit of the memory line and a flag bit for identifying the memory line;
obtaining a value of the flag bit of the memory line by performing an ECC check on the flagged memory line using the ECC checksum of the memory line;
restoring the flagged memory line to the memory line according to the value of the flag bit; and
determining whether or not to load the memory line according to the value of the flag bit and the type of the load access request from the processor.

2. The method according to claim 1, further comprising loading the application before reading from the memory the flagged memory line and the ECC checksum corresponding to the memory line, wherein loading of the application comprises:
in response to receiving an application load request from the processor, receiving the memory line and the flag bit for identifying the memory line;
performing ECC coding on the memory line to generate an ECC checksum corresponding to the memory line;
performing a logic operation on the predetermined bit of the memory line and the flag bit of the memory line to generate the flagged memory line; and
writing the flagged memory line and the ECC checksum corresponding to the memory line into the memory.

3. The method according to claim 2, wherein obtaining a value of the flag bit of the flagged memory line by performing an ECC check on the flagged memory line further comprises:
performing an ECC check on the flagged memory line to generate a first check result;
performing a non-logic operation on the predetermined bit of the flagged memory line to generate a new flagged memory line;
performing an ECC check on the new flagged memory line to generate a second check result; and
obtaining the value of the flag bit of the memory line according to the first check result and the second check result.

4. The method according to claim 3, wherein obtaining the value of the flag bit of the memory line according to the first check result and the second check result further comprises:
if the first check result indicates that the predetermined bit of the flagged memory line is in error, and the second check result indicates that the new flagged memory line has no error, determining the value of the flag bit as a protection flag bit;
if the first check result indicates that the flagged memory line has no error, and the second check result indicates that the predetermined bit of the new flagged memory line is in error, determining the value of the flag bit as a non-protection flag bit;
if the first check result indicates that the flagged memory line has two bits in error, and the second check result indicates that the new memory line has one bit other than the predetermined bit in error, determining the value of the flag bit as a protection flag bit; and
if the first check result indicates that the flagged memory line has one bit other than the predetermined bit in error, and the second check result indicates that the new flagged memory line has two bits in error, determining the value of the flag bit as a non-protection flag bit.

5. The method according to claim 4, further comprising determining values of the flag bits corresponding to the plurality of memory lines by using a majority decision principle.

6. The method according to claim 4, wherein determining whether or not to load the memory line according to the value of the flag bit and the type of the load access request from the processor further comprises:
if it is determined that the value of the flag bit is the protection flag bit and the load access request from the processor is a data acquisition request, prohibiting loading the memory line.

7. The method according to claim 6, wherein the protection flag bit is set by a decryption accelerator for the application.

8. A memory controller for protecting an application in a memory, the application being cached as memory lines according to a size of a cache line, the memory controller comprising:
a reading module configured to, in response to a load access request from a processor, read from the memory a flagged memory line and an ECC checksum corresponding to the memory line, wherein the flagged memory line is obtained by performing a logic operation on a predetermined bit of the memory line and a flag bit for identifying the memory line;
an ECC check module configured to obtain a value of the flag bit of the memory line by performing an ECC check on the flagged memory line using the ECC checksum of the memory line;
a restoring module configured to restore the flagged memory line to the memory line according to the value of the flag bit; and
a load determining module configured to determine whether or not to load the memory line according to the value of the flag bit and the type of the load access request from the processor.

9. The memory controller according to claim 8, further comprising:
a receiving module configured to, in response to receiving an application load request from the processor, receive from a decryption accelerator the memory line and the flag bit for identifying the memory line;
an ECC coding module configured to perform ECC coding on the memory line to generate an ECC checksum corresponding to the memory line;
a flagged memory line generating module configured to perform an exclusive-OR logic operation on the predetermined bit and the flag bit of the memory line to generate a flagged memory line; and
a memory writing module configured to write the flagged memory line and the ECC checksum corresponding to the memory line into the memory.

10. The memory controller according to claim 9, wherein the ECC checking module is further configured to:
perform an ECC check on the flagged memory line to generate a first check result;
perform a non-logic operation on the predetermined bit of the flagged memory line to generate a new flagged memory line;
perform an ECC check on the new flagged memory line to generate a second check result; and
obtain the value of the flag bit of the flagged memory line according to the first check result and the second check result.

11. The memory controller according to claim 10, wherein the ECC checking module is further configured to:
if the first check result indicates that the predetermined bit of the flagged memory line is in error, and the second check result indicates that the new flagged memory line has no error, determine the value of the flag bit as a protection flag bit;
if the first check result indicates that the flagged memory line has no error, and the second check result indicates that a predetermined bit of the new flagged memory line is in error, determine the value of the flag bit as a non-protection flag bit;
if the first check result indicates that the flagged memory line has two bits in error, and the second check result indicates that the new memory line has one bit other than the predetermined bit in error, determine the value of the flag bit as a protection flag bit; and
if the first check result indicates that the flagged memory line has one bit other than the predetermined bit in error, and the second check result indicates that the new flagged memory line has two bits in error, determine the value of the flag bit as a non-protection flag bit.

12. The memory controller according to claim 11, further comprising a determining module configured to determine values of the flag bits corresponding to the plurality of memory lines by using a majority decision principle.

13. The memory controller according to claim 11, wherein the load determining module is further configured to:
if it is determined that the value of the flag bit is the protection flag bit and the load access request from the processor is a data acquisition request, prohibit loading the memory line.

14. The memory controller according to claim 13, wherein the protection flag bit is set by a decryption accelerator for the application.

15. A processor architecture for protecting an application in a memory, the application being cached as memory lines according to a size of a cache line, the processor architecture comprising a memory controller, the memory controller comprising:
a reading module configured to, in response to a load access request from a processor, read from the memory a flagged memory line and an ECC checksum corresponding to the memory line, wherein the flagged memory line is obtained by performing a logic operation on a predetermined bit of the memory line and a flag bit for identifying the memory line;
an ECC check module configured to obtain a value of the flag bit of the memory line by performing an ECC check on the flagged memory line using the ECC checksum of the memory line;
a restoring module configured to restore the flagged memory line to the memory line according to the value of the flag bit; and
a load determining module configured to determine whether or not to load the memory line according to the value of the flag bit and the type of the load access request from the processor.
